(19) United States
(12) Patent Application Publication
(10) Pub. No.: US 2014/0133163 A1
(43) Pub. Date: May 15, 2014

(54) LIGHTING DEVICE, CORRESPONDING SUPPORT AND CORRESPONDING METHOD

(71) Applicant: OSRAM GmbH, Muenchen (DE)

(72) Inventors: Alessandro Scordino, Dolo (Venezia) (IT); Franco Zanon, Cassola (IT)

(73) Assignee: OSRAM GmbH, Muenchen (DE)

(21) Appl. No.: 14/070,611

(22) Filed: Nov. 4, 2013

(30) Foreign Application Priority Data
Nov. 13, 2012 (IT) TO2012A000982

(51) Int. Cl. F21V 21/096

(52) U.S. Cl. CPC F21V 21/096
USPC 362/368; 29/832

(57) ABSTRACT

In various embodiments, a lighting device for mounting on a mounting surface is provided. The device may include: a planar solid state lighting module having a light emitting region; a housing which frames the lighting module, the housing having a window therein to expose the light emitting region of the lighting module; wherein the housing is magnetically attractable towards the mounting surface to retain the lighting module applied onto the mounting surface by the lighting module being sandwiched between the mounting surface and the housing magnetically attracted towards the mounting surface.

### CROSS-REFERENCE TO RELATED APPLICATION

This application claims priority to Italian Patent Application Serial No. TO 2012 A 000982, which was filed Nov. 13, 2012, and is incorporated herein by reference in its entirety.

### TECHNICAL FIELD

Various embodiments relate generally to lighting devices. Various embodiments may relate to solid state lighting (SSL) devices using, for example, LED light radiation sources.

### BACKGROUND

In solid state lighting (SSL) applications, there has of late been the tendency to define lighting module geometries such as to allow standard mechanical interconnections in order to simplify the installation of the systems and to facilitate the relative interchangeability.

By way of example, in March 2012, the Zhaga consortium approved specifications called “Flat Emitter Streetlight Engine with Separate Control Gear (Book 4)”, which standardize the principal geometries of the boards, the dimensions of the light radiation emitting surface (light emitting surface or LES) and the positions of holes provided for screwing lighting modules onto the relative mounting surfaces.

It has been noted that the installation (or replacement) procedure for the lighting module could be simplified, making it achievable for any operator, if it were possible to avoid having to screw a lighting module or light engine onto a heat sink, or, in general, onto the structure of a lighting device (luminaire).

This is even the case taking into consideration the fact that streetlighting devices are often mounted on poles or on portals or rather are suspended on cables at heights of 6-8 meters with respect to street level, which makes the installation operations more complex.

### SUMMARY

In various embodiments, a lighting device for mounting on a mounting surface is provided. The device may include: a planar solid state lighting module having a light emitting region; a housing which frames the lighting module, the housing having a window therein to expose the light emitting region of the lighting module; wherein the housing is magnetically attractable towards the mounting surface to retain the lighting module applied onto the mounting surface by the lighting module being sandwiched between the mounting surface and the housing magnetically attracted towards the mounting surface.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows schematically shows a lighting system according to embodiments;

FIGS. 2 to 8 show various components of embodiments; and

FIGS. 9 to 13 show details of the mounting sequence of embodiments.

### DESCRIPTION

In the following description, various specific details aimed at providing a fuller understanding of various exemplary embodiments are explained. The embodiments may be implemented without one or more of the specific details or using other methods, components, materials, etc. In other cases, known structures, materials or operations are not shown or described in detail so that the various aspects of the embodiments may be understood more clearly.

The reference to “an embodiment” in the context of this description indicates that a particular configuration, structure or feature described in relation to the embodiment is included in at least one embodiment. Therefore, phrases such as “in one embodiment”, which may occur at various points in this description, do not necessarily refer to the same embodiment. Moreover, particular forms, structures or features may be combined in any suitable manner in one or more embodiments.

The reference signs used here are provided solely for the sake of convenience and therefore do not define the scope of protection or ambit of the embodiments.

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments provide solutions which make it possible for lighting modules (for example compliant with the Zhaga standards) to be installed/replaced without this requiring screw tightening and/or loosening operations.

Various embodiments provide a lighting device having the features indicated specifically in the claims which follow. Various embodiments may also relate to a support for mounting such a device and also to a corresponding mounting method. The claims form an integral part of the technical teaching provided here in relation to the various embodiments.

In various embodiments, a lighting device includes a mounting housing which is magnetically attractable towards the mounting surface, for example by means of magnets mounted on the housing and ferromagnetic members which are fixed (for example screwed) onto the mounting surface and can attract the magnets, and therefore the housing of the lighting device, towards the mounting surface. Various embodiments may therefore overcome the restrictions introduced by the Zhaga specifications, with the standardization of the position of threaded fixing holes, by using ferromagnetic fixing members which can be screwed into the aforementioned holes. Various embodiments may make it possible for the mounting support of the lighting device to be equipped with members of this type by means of a simple manual screwing operation, so that tools of any kind are not required.

Various embodiments make it possible to achieve one or more of the following advantages:
exceptional cost-effectiveness of the solution,
possibility to avoid resorting to special tools for mounting the system,
simplified installation,
compliance with the Zhaga standards,
assembly of the LED module without screwing operations.

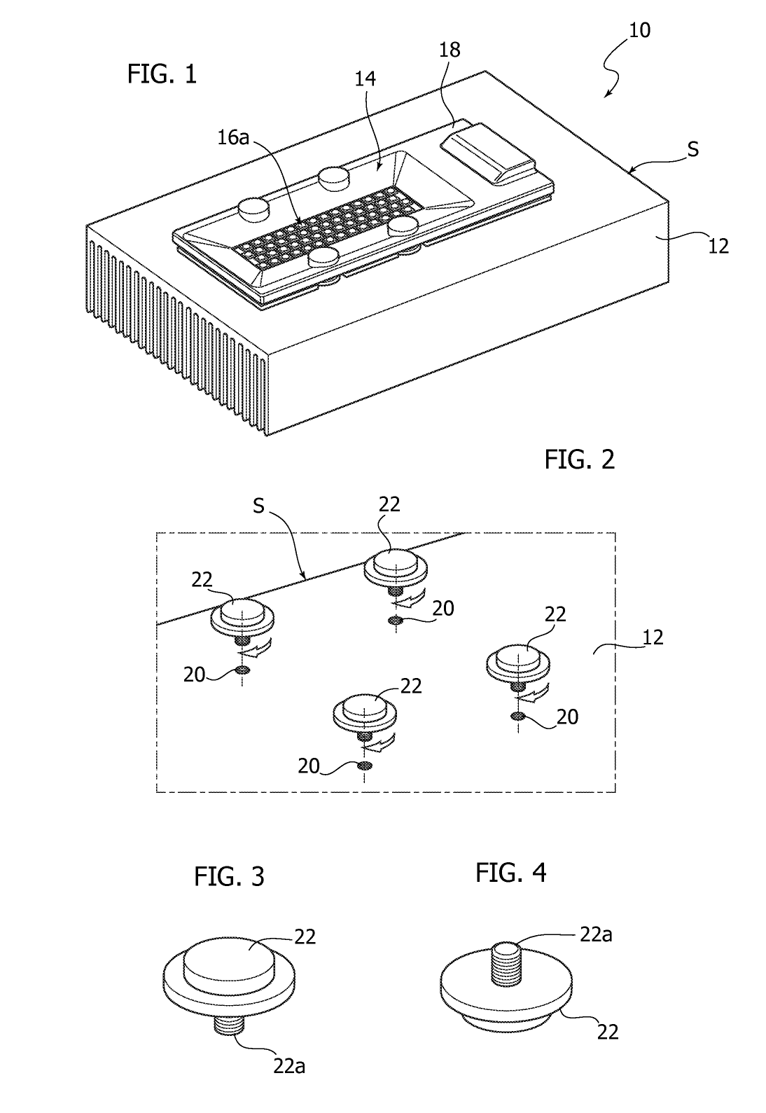

In FIG. 1, reference sign 10 denotes a lighting system (luminaire), for example for streetlighting, in its entirety, which lighting system can be mounted on a pole or on a portal or rather can be suspended on a cable.

The operations for mounting and for electrically connecting such a lighting system (such as the possible positioning of the system 10 inside a housing for protecting against ambient agents) can be carried out and conducted according to known criteria, and therefore a detailed description is not required at this point.

In various embodiments, the system 10 can include a support 12 which, in various embodiments, can be configured as a heat sink and can have a surface S, for example a flat surface, which is suitable for acting as a mounting surface for a lighting device 14.

In various embodiments, the lighting device 14 may in turn include:
a lighting module 16, formed for example by a planar solid state lighting module including a light radiation source 16a (for example by an array of LEDs mounted on a planar substrate 16b which resembles a printed circuit board (PCB)), and
a housing 18 which can frame the lighting module 16 and has a window 18a therein which makes it possible to expose (allowing the emission of the light radiation externally of the device 10) the light emitting region of the module 16, that is the region in which the light radiation source 16a is located.

In various embodiments, the window 18a can be open or permeable, and therefore the light radiation source (that is the LEDs mounted in the region 16a) is directly exposed to the outside.

In various embodiments, the window 18a can be closed by a transparent (that is “permeable to the light radiation”) screen, and therefore the light radiation source is exposed to the outside indirectly, through the transparent screen mounted in the window 18a.

As can be seen more clearly in FIG. 2, in various embodiments an array of holes 20, for example threaded holes, for the insertion of fixing screws can be present on the surface S provided for mounting the device 14. In various embodiments, the holes 20 can be positioned at positions determined according to the Zhaga standards.

Various embodiments may be based on the principle of not directly screwing the device 14 onto the surface S, and of realizing the mounting by magnetic means, that is by mounting members on the surface S, at the holes 20, in such a way that the device 14, e.g. the housing 18, can be magnetically attractable towards the surface S.

In this way, the lighting module 16 can be retained applied onto the mounting surface S in that it is sandwiched between the mounting surface S and the housing 18 magnetically attracted towards the mounting surface S.

In various embodiments, the fixing of the device 14 on the surface S, instead of being achieved by direct screwing (that is by means of screws which are screwed into the holes 20 and which tighten the device 14 against the surface S), can be effected as a magnetic mounting realized on account of members (such as indeed the members 22) screwed into the holes 20.

As can be seen more clearly by observing FIG. 2 to FIG. 4, in various embodiments the members 22 may have a general button-like or token-like (or coin-like) form; in respect of all of this, it is moreover necessary to note that the circular shape shown by way of example in the figures is not in any way imperative for the embodiments: the members can therefore have different shapes, for example polygonal shapes.

In various embodiments, the members 22 can be screwed into the holes 20 with the aid of a threaded tang 22a. The tang 22a can therefore be fitted into a respective hole 20 in the surface S and screwed into said hole by acting on the member 22, with a simple manual action—and therefore without having to resort to particular tools—for example until the member 22 rests on the surface S, anchored thereto.

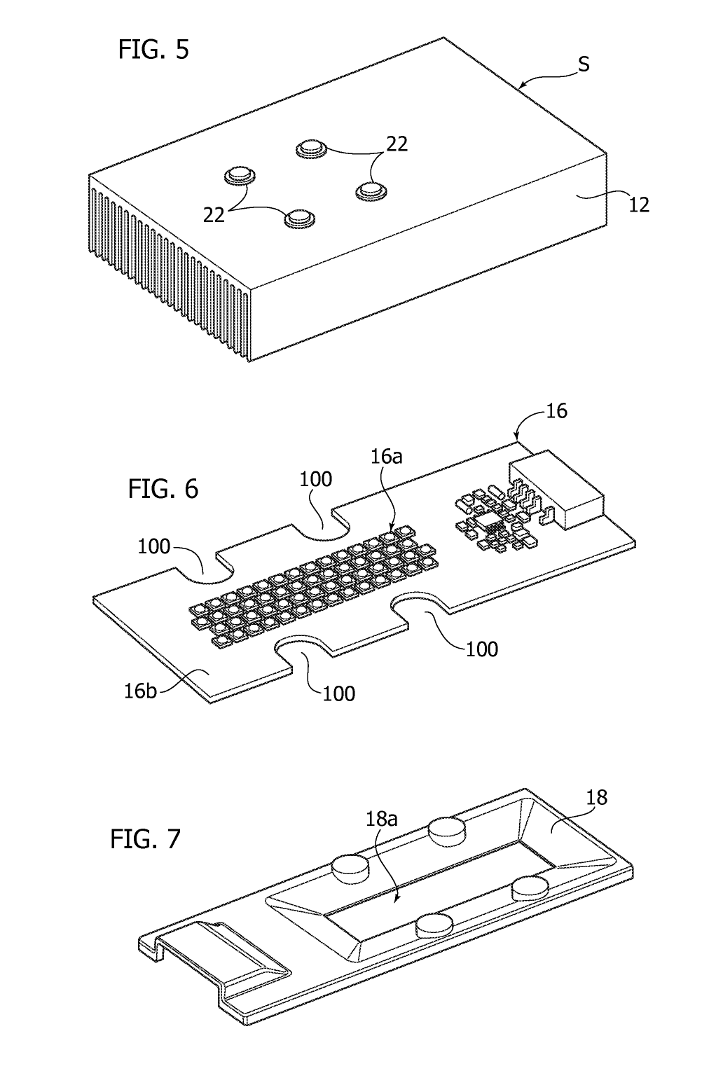

FIG. 5 shows four members 22 fixed in this way onto the surface S.

It will be understood moreover that the presence of four members 22, screwed into four holes 20 positioned at the vertices of an ideal square, is shown purely by way of example: the number and the position of the holes 20 and of the members 22 could indeed be different. Various embodiments can therefore easily adapt to holes 20 of which both the number and the arrangement comply, for example, with Zhaga specifications and/or with different specifications, even of future definition.

In various embodiments, as can be seen more clearly in FIG. 6, the lighting module 16 can have (made, for example, in the planar substrate 16b) U-shaped notches or incisions 100 located at positions corresponding to the positions of the members 22 (and therefore of the holes 20). In various embodiments, the notches or incisions 100 can be arranged along opposite sides of the substrate 16b of the module 16.

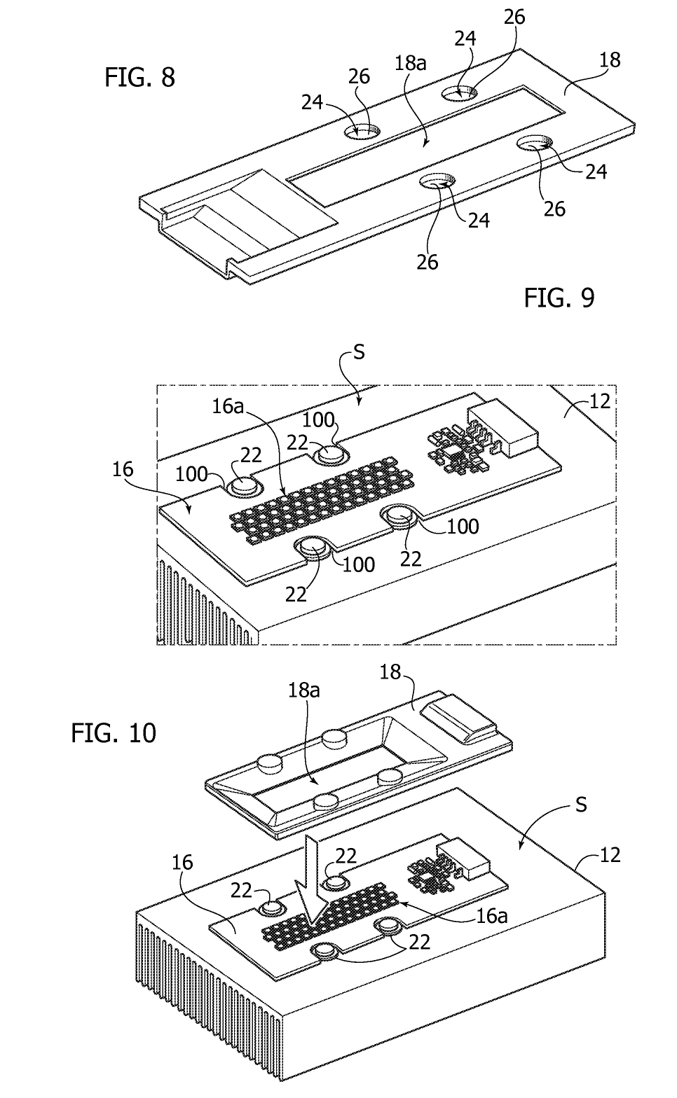

In various embodiments, the housing 18, of which FIG. 7 and FIG. 8 provide two perspective views from roughly opposite points of observation, has a general frame-like shape.

In various embodiments, cavities 24, into which members 26 intended to cooperate with the members 22 to realize the magnetic attraction force can be inserted, may be present in the housing 18, for example on the side intended to face towards the surface S and along the outline of the window 18a.

In various embodiments, this outcome can be obtained with the aid of members 22 and 26 having magnetic attraction features.

To this end, in various embodiments the members 26 may include a magnetized (ferro) magnetic material (for example magnetized plastoferrite or another magnetic material currently used in electrical engineering), so as to generate a magnetic field in order to attract the members 22, which in turn may include a ferromagnetic material which is not magnetized per se (for example soft iron or another suitable material).

This magnetic attraction force ensures that the housing 18, on which the magnets 26 are mounted, is magnetically attractable towards the surface S, on which the members 22 are fixed (screwed).

The same outcome may be achieved in a complementary manner, that is with the members 22 being magnets which attract the members 26 which act as an anchor, or by realizing both the members 22 and the members 26 as mutually attracting magnets. In various embodiments, the relative arrangement of the magnet and of the anchor material attracted thereby can differ from pair to pair of complementary members 22 and 26.

Various embodiments may therefore provide that the housing 18 includes a plurality of magnetically attractive or magnetically attractable members carried by said housing 18, e.g. at the periphery of the housing, that is along the outline of the window 18a.

In various embodiments, the members 26 may be mounted in the cavities 24 by interference mounting. In various embodiments, the members 26 may be co-molded directly with the housing 18, for example when, according to various embodiments, the housing 18 is made of molded plastic material.

FIG. 9 and those which follow schematically show the sequence for mounting a device 14 on a support 12, on which the members 22 have been mounted pre-emptively (by being screwed into the holes 20).

FIG. 9 shows the possibility of having the lighting module 16 resting on the surface S, which bears the notches 100 at the members 22 in such a way that each notch 100 embraces a respective member 22.

In various embodiments, the dimensions of the notches 100 may be chosen so as to be coordinated with the dimensions of the members 22, so as to ensure that the outlines of the notches 100 embrace the members 22 with a certain clearance, thereby avoiding a force fit which is capable of inducing mechanical stresses in the substrate 16b of the module 16.

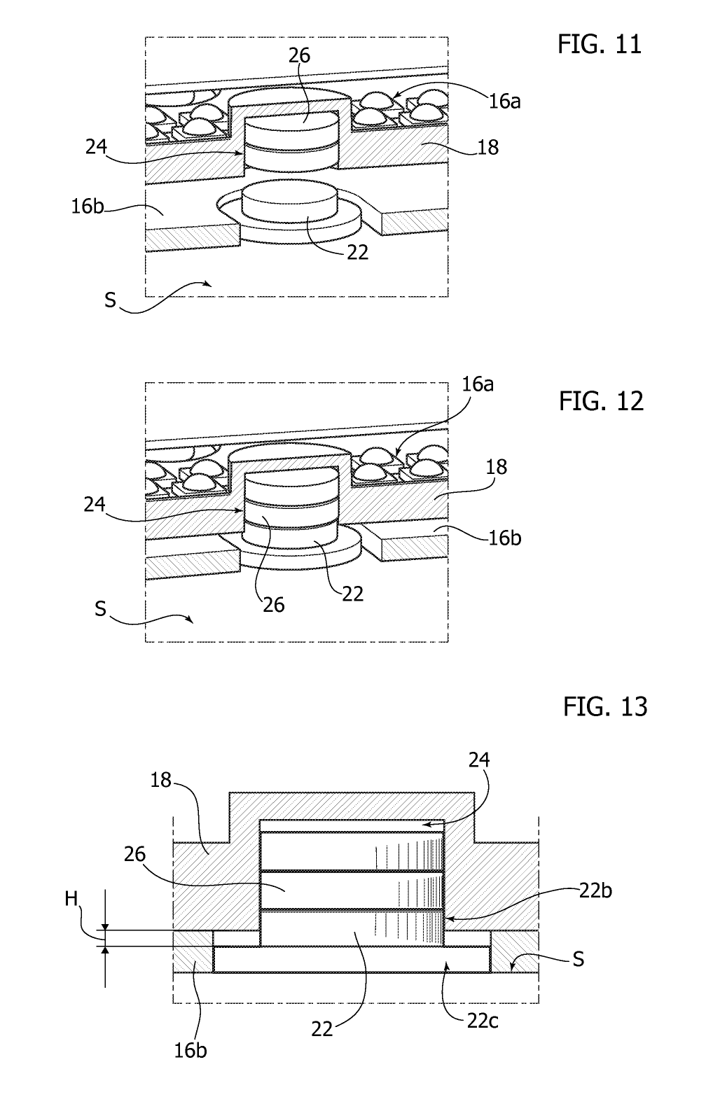

As shown schematically in FIG. 10, the housing 18 may be applied from above the module 16, carrying the cavities 24 (in the inside of which the members 26 are located) in alignment with the members 22 (in this respect, see the sequence of FIG. 11 to FIG. 13).

In various embodiments, the dimensions of the cavities 24 and/or the shape/dimensions of the members 22 can be chosen such that the members 22 can at least partially penetrate into the cavities 24, ensuring exact relative positioning between the housing 18 and the module 16.

By way of example, in various embodiments the members 22 may have an upper portion 22b having smaller radial dimensions than the base portion 22c facing towards the surface S; for illustrative simplicity, the presence of these two portions, which are clearly identifiable in a number of the accompanying figures, is denoted explicitly by reference signs 22b and 22c only in FIG. 13.

FIG. 13 also shows the fact that, in various embodiments, the height or thickness of the base portions 22c (that is the dimension in a direction orthogonal with respect to the plane of extent of the surface S) of the members 22 is chosen so as to be at least slightly smaller than the same dimension (that is, in practice, than the thickness) of the substrate 16b of the module 16.

In this way, a gap or interval H is created between the upper circular ring face of the base 22c of the members 22 and the surface of the housing 18 facing the latter. In this way, the face of the housing 18 which faces and is attracted towards the surface S is able to press the substrate 16b against the surface S with a constant and uniform pressure so as to optimize the heat exchange during operation.

The assembly sequence shown schematically in FIG. 9 to FIG. 13 may be reproduced in a contrary way if the housing 18 is to be removed, for example in order to be able to replace the module 16, it then being possible to again mount a new module 16 according to the sequence shown here.

The relative operations may be carried out manually, without having to resort to specific tools, it being possible to operate in a simple and easy manner even in the case of lighting systems 10 which are mounted at a certain height with respect to the ground.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting device for mounting on a mounting surface, the device comprising:
a planar solid state lighting module having a light emitting region;
a housing which frames the lighting module, the housing having a window therein to expose the light emitting region of the lighting module;
wherein the housing is magnetically attractable towards the mounting surface to retain the lighting module applied onto the mounting surface by the lighting module being sandwiched between the mounting surface and the housing magnetically attracted towards the mounting surface.

2. The device of claim 1,
wherein the housing includes a plurality of magnetically attractive or magnetically attractable members carried by the housing.

3. The device of claim 2,
wherein the housing includes a plurality of magnetically attractive or magnetically attractable members carried by the housing at the periphery of the housing.

4. The device of claim 2,
wherein the lighting module includes a flat substrate having peripheral notches for positioning at said magnetically attractive or magnetically attractable members.

5. The device of claim 1,
wherein the housing is magnetically attractable towards the mounting surface by a plurality of pairs of mutually magnetically attractive members, each pair including:
a first member carried by the housing: and
a second member for fixing to the mounting surface.

6. The device of claim 5,
wherein the second member in the pair includes a button-like member including a threaded formation for fixing to the mounting surface by screwing.

7. The device of claim 5,
wherein the first member in the pair is located in a cavity in the housing, with the second member in the pair is at least partly insertable into the cavity (24).

8. The device of claim 5,
wherein one member in the pair is magnetized and acts as an attractive magnet and the other member in the pair is ferromagnetic and acts as an anchor attracted by the magnet.

9. The device of claim 5,
wherein the peripheral notches in the flat substrate are dimensioned to surround with clearance said pairs of magnetically attractive or magnetically attractable members.

10. A support for mounting a lighting device, the lighting device comprising:
a planar solid state lighting module having a light emitting region;
a housing which frames the lighting module, the housing having a window therein to expose the light emitting region of the lighting module;
wherein the housing is magnetically attractable towards the mounting surface to retain the lighting module applied onto the mounting surface by the lighting module being sandwiched between the mounting surface and the housing magnetically attracted towards the mounting surface.
the support comprising:
a mounting surface provided with fixing cavities for the lighting device, said cavities having fixed therein magnetically attractive or magnetically attractable members to produce magnetic attraction of the housing of the lighting device towards the mounting surface.

11. The support of claim 10,
wherein the housing includes a plurality of magnetically attractive or magnetically attractable members carried by the housing.

12. The support of claim 11,
wherein the housing includes a plurality of magnetically attractive or magnetically attractable members carried by the housing at the periphery of the housing.

13. The support of claim 11,
wherein the lighting module includes a flat substrate having peripheral notches for positioning at said magnetically attractive or magnetically attractable members.

14. The support of claim 10,
wherein the housing is magnetically attractable towards the mounting surface by a plurality of pairs of mutually magnetically attractive members, each pair including:
a first member carried by the housing: and
a second member for fixing to the mounting surface.

15. The support of claim 14,
wherein the second member in the pair includes a button-like member including a threaded formation for fixing to the mounting surface by screwing.

16. The support of claim 14,
wherein the first member in the pair is located in a cavity in the housing, with the second member in the pair is at least partly insertable into the cavity (24).

17. The support of claim 14,
wherein one member in the pair is magnetized and acts as an attractive magnet and the other member in the pair is ferromagnetic and acts as an anchor attracted by the magnet.

18. The support of claim 14,
wherein the peripheral notches in the flat substrate are dimensioned to surround with clearance said pairs of magnetically attractive or magnetically attractable members.

19. A method of mounting onto a mounting surface a planar solid state lighting module comprising a light emitting region, the method comprising:
providing a housing to frame the lighting module, the housing comprising a window therein to expose the light emitting region of the lighting module, wherein said housing is provided as a housing magnetically attractable towards the mounting surface to retain the lighting module applied onto the mounting surface by the lighting module being sandwiched between the mounting surface and the housing magnetically attracted to the mounting surface.
